(19) United States
(12) Patent Application Publication
(10) Pub. No.: US 2016/0375774 A1
(43) Pub. Date: Dec. 29, 2016

(54) PERMANENT MAGNET-EXCITED ELECTRIC MACHINE

(71) Applicant: VOITH PATENT GMBH, Heidenheim (DE)

(72) Inventors: BERND LAUTER, SONTHEIM AN DER BRENZ (DE); JOHANNES GLONING, ELLWANGEN (DE)

(21) Appl. No.: 14/902,520

(22) PCT Filed: Jul. 2, 2014
(86) PCT No.: PCT/EP2014/064011

§ 371 Date: Dec. 31, 2015

(30) Foreign Application Priority Data
Jul. 4, 2013 (DE) 10 2013 213 044.9

(51) Int. Cl. B60L 3/00; H02P 27/06; H02P 29/024; B60L 3/04; H02P 3/14

(52) U.S. Cl. CPC B60L 3/0061; B60L 3/04; H02P 3/14; H02P 29/024; H02P 27/06; B60L 2240/42

(57) ABSTRACT

A method for controlling a multiphase frequency converter for controlling an electric machine which is suitable as a traction drive of a vehicle. The frequency converter includes power circuit pairs with series-connected first and second power switches. The first power switch is connected to a DC voltage and the second power switch is connected to a ground of the DC voltage. Each node between the first power switch and the second power switch is connected to the respective phase conductor of the electric machine. The method includes ascertaining whether a fault is present, if a fault is present and a control signal at the first and/or the second power switch is not active: assessing whether the frequency converter should be switched into the short-circuit mode or into the freewheeling mode based on the phase conductor currents and/or based on the position of the rotor of the electric machine.

### FIELD OF THE INVENTION

The present invention relates to a method for controlling a multiphase frequency converter for controlling an electric machine, and to a control unit and a vehicle.

### BACKGROUND OF THE INVENTION

Permanent magnet-excited synchronous machines which are used to drive vehicles are known from the prior art.

### SUMMARY OF THE INVENTION

Permanent magnet-excited electric machines as traction drives of an electric or hybrid vehicle usually cannot be mechanically decoupled from the drive axle, the wheel, or the wheels. One property of permanent magnet-excited electric machines is that these generate a voltage which is proportional to the machine speed. If this voltage increases above the present intermediate circuit voltage and the on-state voltage of the diodes of the power switch (or the body diodes of the MOSFETs), feedback occurs. Due to the feedback, the danger exists that the DC voltage source will become damaged by overloading of the frequency converter with overcurrent. In addition, the feedback results in an unwanted braking torque which is opposed to the rotational direction of the machine shaft. In order to avoid this problem, the electric machine can be transferred into a freewheeling mode or a short-circuit mode. It must be taken into account in this case, however, that a short-circuited, permanently excited electric machine can generate a high braking torque at low speeds. In the case of freewheeling, however, a high braking torque can be generated at high speeds. A switch between the freewheeling mode and the short-circuit mode must therefore be carried out according to the situation. The machine speed, as an indicator of which mode to switch to (short-circuit mode or freewheeling mode), cannot be the only criterion used, since the utility of this criterion is influenced by additional parameters. The critical machine speed, as a value of the machine speed at which a switchover of the frequency converter should take place, is dependent, for example, on the present level of the DC voltage available at the frequency converter (intermediate circuit voltage). The lower the intermediate circuit voltage is, the lower the absolute value of the speed/machine speed is at which feedback occurs in the uncontrolled mode. In addition, the temperature of the permanent magnets disposed at the rotor of the electric machine plays a significant role. The magnetic field strength thereof decreases as the temperature increases, which is why a cold rotor induces substantially more voltage than a warm rotor at the same speed. The stator resistance varies as a result of the temperature of the stator winding, whereby an influence on the speed threshold also results. In particular, a great deal of technical complexity is required in order to measure the rotor temperature or the magnetic field strength of the permanent magnets.

One object is therefore that of providing a method for an electric machine, which allows a switchover into a short-circuit mode or a freewheeling mode under certain conditions, wherein a simple or unambiguous decision-making process is intended to be provided therefor. In particular, a method is intended to be described, which does not require a measurement of the intermediate circuit voltage and/or the rotor temperature and/or the stator temperature in order to fulfill this object.

As a first embodiment of the invention, a method for controlling a multiphase frequency converter for controlling an electric machine is provided, wherein the electric machine is suitable as a traction drive of a vehicle, wherein the frequency converter comprises power circuit pairs, each of which has a first power switch and a second power switch, which are connected in series, wherein the first power switch is connected to a DC voltage and the second power switch is connected to a ground of the DC voltage, wherein each node between the first power switch and the second power switch is connected to the respective phase conductor of the electric machine, having the steps: ascertaining whether a fault is present and, if a fault is present and a control signal at the first and/or at the second power switch is not active: assessing whether the frequency converter should be switched into the short-circuit mode or into the freewheeling mode on the basis of the phase conductor currents and/or on the basis of the position of the rotor of the electric machine.

By utilizing the phase conductor currents or the rotor position in order to make a decision regarding the suitable mode (freewheeling mode, short-circuit mode) of an electric machine during a fault, the speed can be omitted as a criterion which is not unambiguous and it is not necessary to carry out additional measurements, since the phase conductor currents and the rotor position is known.

As a second embodiment of the invention, a control unit is provided for carrying out a method as claimed in one of claims 1 to 11.

As a third embodiment of the invention, a vehicle having a control unit as claimed in claim 12 is provided.

Exemplary embodiments are described in the dependent claims.

According to one exemplary embodiment of the invention, a method is provided, further having the step: mathematically transforming the phase conductor currents into a two-dimensional coordinate system having current components situated orthogonal to one another and/or wherein the coordinate system is a rotor-oriented coordinate system.

By means of a transformation into a rotor-oriented coordinate system, simplified conditions can be created, wherein the process of deciding which mode of the frequency converter to switch to can be simplified.

In a further embodiment according to the invention, a method is provided, further having the steps: if the current components are within a tolerance range: transferring the output stage into a freewheeling mode, if the current components are outside the tolerance range: if the control signal is active: if the current components are outside a first range: transferring the frequency converter into the freewheeling mode.

According to a further exemplary embodiment of the present invention, a method is provided, further having the steps: if the current components are outside the tolerance range: if the control signal is not active: transferring the frequency converter into the short-circuit mode, if the current components are outside the tolerance range: if the control signal is active: if the current components are within a first range: transferring the frequency converter into the short-circuit mode.

According to one exemplary embodiment of the invention, a method is provided, wherein the tolerance range is the range in which the following applies for the current components: i_{q}²+i_{d}²=first value, and/or wherein the first range is the range in which the following applies for the current components: i_{d}<0 and (i_{q}<=| second value·i_{d}| and i_{q}>=third value·i_{d}) and/or wherein the first value, the second value, and the third value are any identical or different numerical values and/or wherein the determination as to whether the current components are within the first range takes place by calculating a current angle of the current components and/or by calculating a current ratio of the current components.

In a further exemplary embodiment according to the invention, a method is provided, further having the steps: if the current components are outside the tolerance range: transferring the frequency converter into the short-circuit mode; if the current components are within the tolerance range: leaving the frequency converter in the freewheeling mode.

According to a further exemplary embodiment of the present invention, a method is provided, wherein: if the current components are within a second range: leaving the frequency converter in the short-circuit mode,

if the current components are outside the second range: transferring the frequency converter into the disconnect mode.

According to one exemplary embodiment of the invention, a method is provided, wherein the second range is the range in which the following applies for the current components: i_{d}<0 and (i_{q}<=0 and i_{q}>=fourth value·i_{d}), wherein the fourth value is any numerical value and/or wherein the second range takes place by calculating a current angle of the current components and/or by calculating a current ratio of the current components.

According to one exemplary embodiment of the invention, a method is provided, wherein all the first and all the second power switches are open in the freewheeling mode.

In a further embodiment according to the invention, a method is provided, wherein, in the short-circuit mode, all the first power switches are open and all the second power switches are closed or wherein all the first power switches are closed and all the second power switches are open or wherein one power switch is short-circuited in each phase.

A short-circuit mode or a freewheeling mode can be easily implemented by controlling the power switch of the frequency converter.

According to a further exemplary embodiment of the present invention, a method is provided, wherein a monitoring unit transfers the frequency converter into the freewheeling mode and/or into the short-circuit mode.

One idea of the invention can be considered to be that of defining conditions, after a transformation into a rotor-oriented coordinate system, which permit a reliable operation of an electric machine. The intention, in particular, in this case is to determine when the electric machine can be switched into a short-circuit mode or into a freewheeling mode if necessary.

The individual features can also be combined with one another, of course, whereby advantageous effects can also result, in part, which go beyond the sum of the individual effects.

### BRIEF DESCRIPTION OF THE DRAWINGS

Further details and advantages of the invention become clear on the basis of the exemplary embodiments represented in the drawings. In the drawings:

FIG. 1 shows an output stage/an inverter/a frequency converter for controlling a permanent magnet-excited synchronous machine,

FIG. 2 shows a representation of the generated braking torque of an inverter during a speed change (speed-torque curve of an uncontrolled, permanent magnet-excited electric machine in the short-circuit mode and in the freewheeling mode, wherein a speed is impressed via the machine shaft),

FIG. 3 shows a system for controlling and monitoring the frequency converter and the electric machine,

FIG. 4 shows a flow chart of a method according to the invention,

FIG. 5 shows a rotor-oriented coordinate system,

FIG. 6 shows a shape of a curve of a synchronous machine in the short-circuit mode at a stator temperature of 20° Celsius and a rotor temperature of 20° Celsius,

FIG. 7 shows a shape of a curve of a synchronous machine in the short-circuit mode at a stator temperature of 20° Celsius and a rotor temperature of 150° Celsius,

FIG. 8 shows a shape of a curve of a synchronous machine in the short-circuit mode at a stator temperature of 150° Celsius and a rotor temperature of 20° Celsius,

FIG. 9 shows a shape of a curve of a synchronous machine in the short-circuit mode at a stator temperature of 150° Celsius and a rotor temperature of 150° Celsius.

### DETAILED DESCRIPTION OF EXEMPLARY EMBODIMENTS

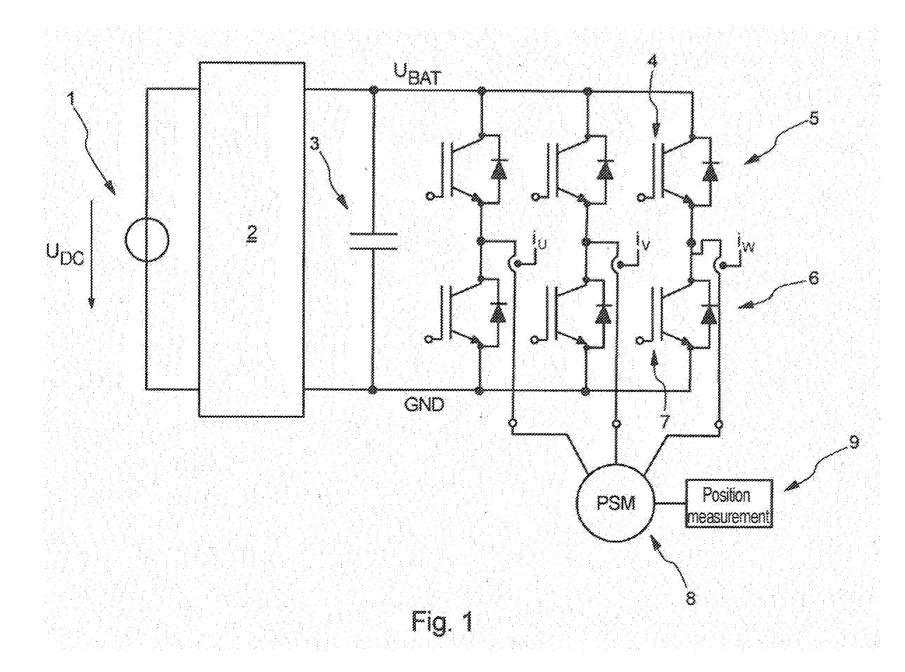

FIG. 1 shows an output stage/an inverter/a frequency converter for controlling a permanent magnet-excited synchronous machine. The inverter comprises three half-bridges/power paths, each of which has a high-side power switch 4 and a low-side power switch 7. The phase conductors of the electric machine 8 are disposed at the nodes of the half-bridges. Diodes/body diodes 5, 6 are disposed/formed at the power switches 4, 7.

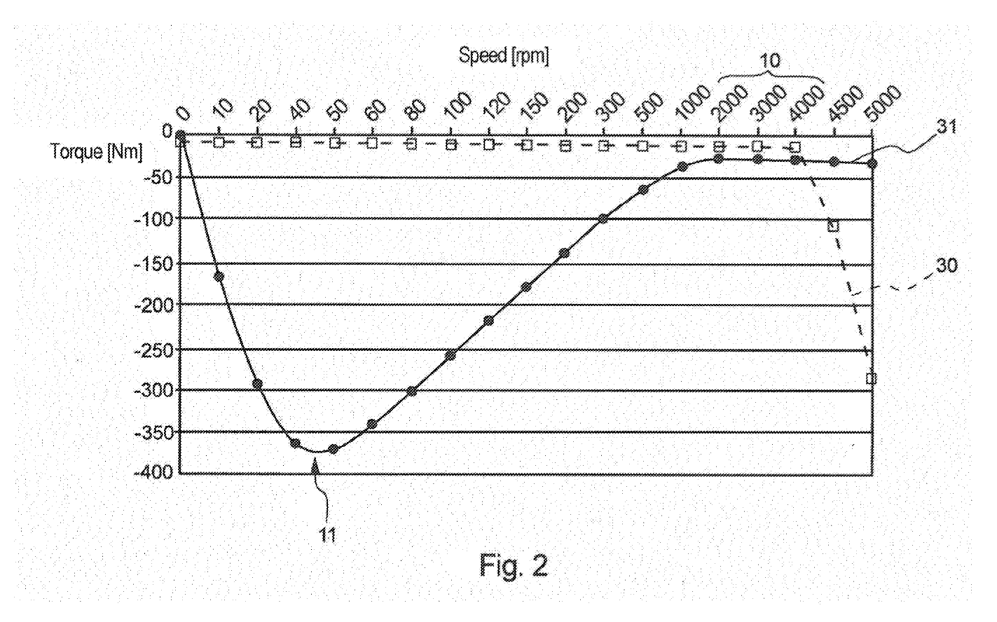

FIG. 2 shows two curves at different operating states of a permanent magnet-excited synchronous machine. The braking torque which is generated in the short-circuit mode is represented in a first curve 31. On the basis thereof, it can be read that high braking torques are generated at low speeds. A maximum 11, at which the highest amount of torque is generated, can be determined. Only a small amount of torque is generated at high speeds in the short-circuit mode. In contrast thereto, only small amounts of torque are generated at low speeds in the freewheeling mode (see curve 30). The amount of torque increases at high speeds. A transition 10 can be determined in this case, up to which it is advantageous to operate the synchronous machine in the freewheeling mode 30 as the speed increases in order to obtain only a small amount of braking torque. After the transition range 10, it is better to switch the synchronous machine into the short-circuit mode 31 in order to keep the braking torque low.

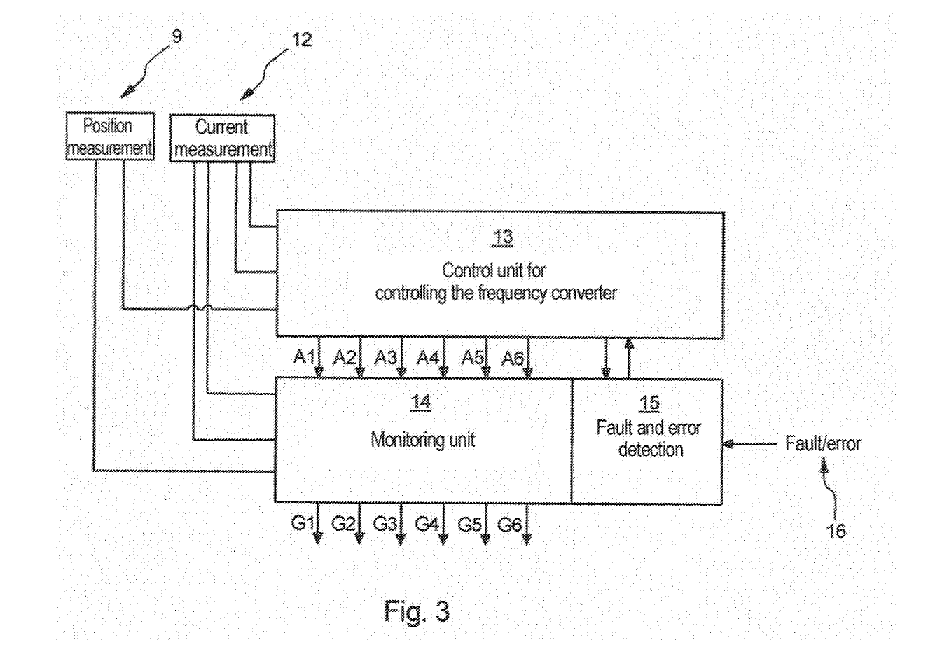

FIG. 3 shows a system for controlling and monitoring the frequency converter and the electric machine. The system has a position measurement 9, with which the position of the rotor of the electric machine/synchronous machine can be determined. The conductor currents i_{U}, i_{V}, i_{W} can be determined by means of a current measurement 12. In addition, the system comprises a control unit for controlling the frequency converter 13 and a fault and error detection 15. The fault and error detection 15 responds both to the external fault/error signal 16 and to faults/errors detected by the monitoring unit 14. The monitoring unit 14 ensures the coordination of the individual elements of the system. If the system receives an error message 16, then, according to the invention, the situation is assessed on the basis of the present machine currents and the position signal of the rotor rather than, as in the prior art, on the basis of speed, intermediate circuit voltage, rotor temperature and/or stator temperature, or further physical variables. Advantageously, according to the invention, the measured variables which are already present can therefore be utilized and additional measurements do not need to be carried out.

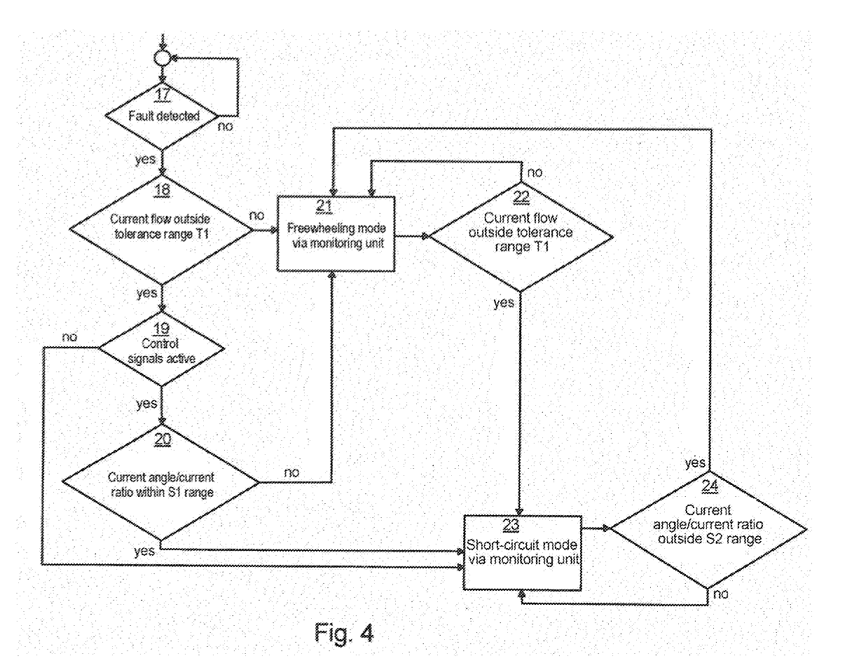

FIG. 4 shows a flow chart of a method according to the invention. Initially it is determined whether a fault is present 17. If so, a check is carried out to determine whether the present current flow is within a range which can be tolerated 18. The only currents in this range T1 are currents which are very low and therefore do not pose a substantial problem. If so, the inverter/frequency converter can be transferred into the freewheeling mode 21. In the freewheeling mode, a check is carried out to determine whether only low currents corresponding to the tolerance range T1 are also present 22. If so, the inverter remains in the freewheeling mode 21. If not, the inverter is transferred into the short-circuit mode 23. After detection of a fault 17 and after determining that the current flow is not unsubstantial, since it is not 18 within the tolerance range T1, if it can also be determined that control signals of the inverter are present 19, it can be ascertained that the control of the inverter can still proceed correctly. If it can be determined, however, that there are no active control signals present 19, the inverter is transferred 23 into the short-circuit mode. If active control signals are present, a check is carried out to determine whether the permanent magnet-excited synchronous machine is actively field-weakened 20 by the converter. This is the case if the transformed currents i_{q}, i_{d} are 20 within the range S1. If this is the case, the inverter is switched 23 into the short-circuit mode in order to avoid damage to the system by currents fed back from the electric machine or by an unwanted torque opposite the direction of rotation. If the transformed values i_{q}, i_{d} are not within the range S1 20, but rather are still on the characteristic curve K_mot, the electric machine is not actively field-weakened and the inverter can be switched 21 into the freewheeling mode.

If the inverter is in the short-circuit mode, a check must be carried out to determine whether it generates a high torque. If so, this can result in an accident risk. For this purpose, a check is carried out to determine whether the current angle/current ratio is 24 outside the range S2. If so, the electric machine generates a high torque and the inverter must be switched 21 into the freewheeling mode. If the result of the calculation of the current angle/current ratio is that these values are still 24 within the range S2, the electric machine does not generate a high torque and can be held 23 in the short-circuit mode.

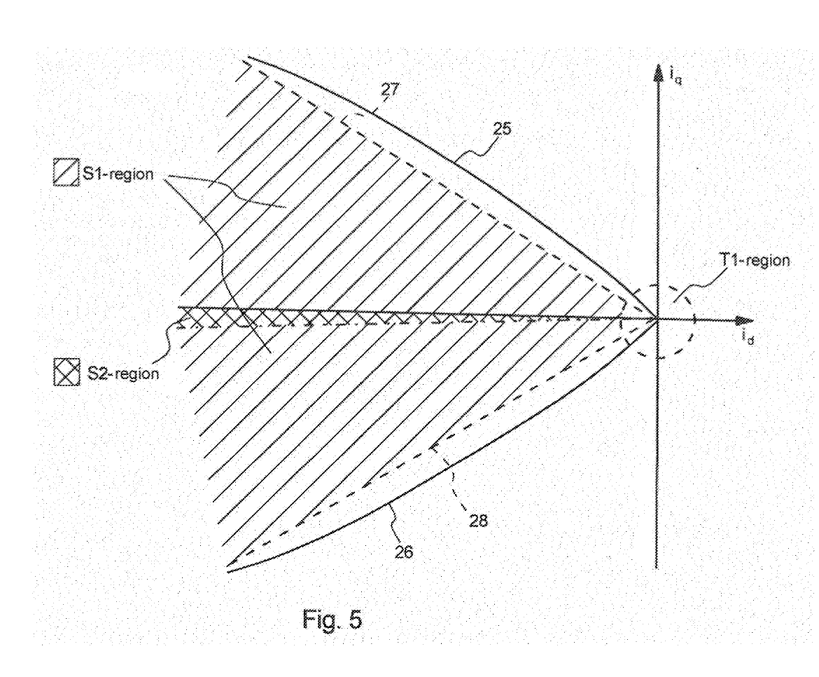

FIG. 5 shows the rotor-oriented coordinate system with d- and q-axes. The characteristic curves K_mot 25 (mot stands for operation as a motor) and K_gen 26 (gen stands for operation as a generator) are represented. If these characteristic curves K_mot 25 and K_gen 26 are departed from, the electric machine is in the state of field weakening and an unwanted feedback would occur in the freewheeling case. The paths/curves 27, 28 can be calculated as a limit value as to whether a significant field weakening is already present. If the electric machine, with respect to the operating state thereof, is within the range S1 spanned by the curves 27, 28, a significant field weakening can be assumed. Two situations which are exceptions can also be determined in this case. If low currents are still present, a non-critical operating state can be assumed, T1 range. In this operating state, the frequency converter can be switched, for example, into the freewheeling mode without having to worry that high feedback currents will result. If the currents are within the range S2, the electric machine generates only a small amount of braking torque. This operating state as well can be assessed as being less critical and can therefore be handled separately. In the case of a cylindrical rotor machine, it is possible to read, on the basis of the d-component (i_{d}), whether the electric machine is operated in the field weakening. If the negative current i_{d} is very high, it can be assumed that the applicable electric machine is functioning in the field weakening mode. The determination as to whether the current components i_{d}, i_{q} are within the S2 range in the short-circuit case can be made on the basis of the ratio of the current components i_{d}, i_{q} with respect to one another or on the basis of the angle of the current indicator resulting from the two current components i_{d}, i_{q}. The current distribution of the component flows i_{d}, i_{q} can be compared to the current angle/current ratio thresholds S1_mot, 27 and S1_gen, 28, respectively, in order to determine whether the current components are within the S1 range. The current angle/current ratio thresholds S1_mot, 27 and S1_gen, 28 can be determined by a fixed angle or a fixed ratio as well as by variable angles/ratios (e.g., based on characteristic curves). The S1 range is the entire range between the curves 27 and 28.

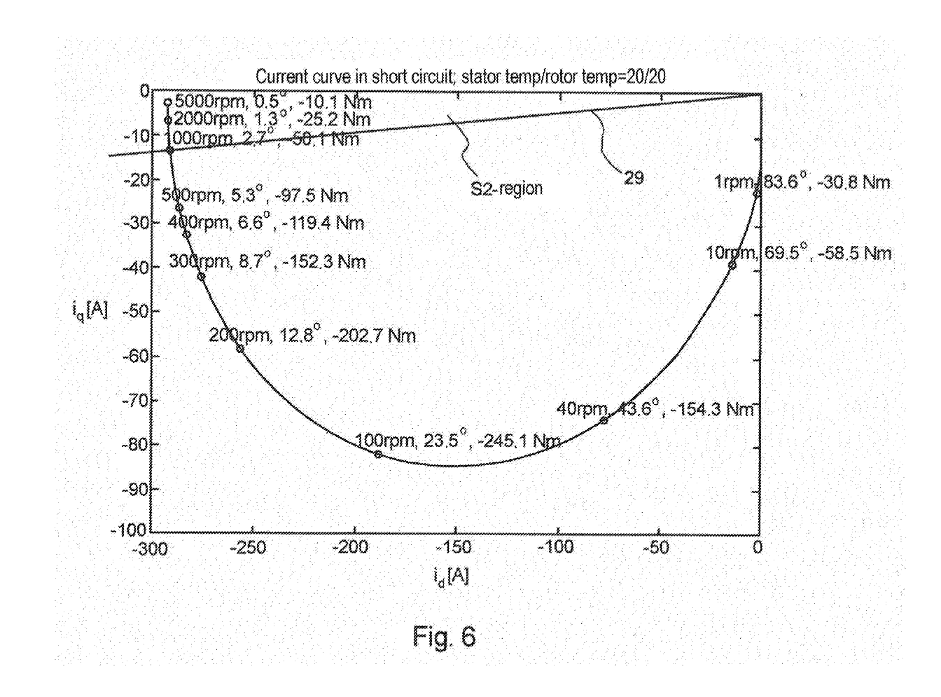

FIG. 6 shows a shape of a curve of a synchronous machine in the short-circuit mode at a stator temperature of 20° Celsius and a rotor temperature of 20° Celsius.

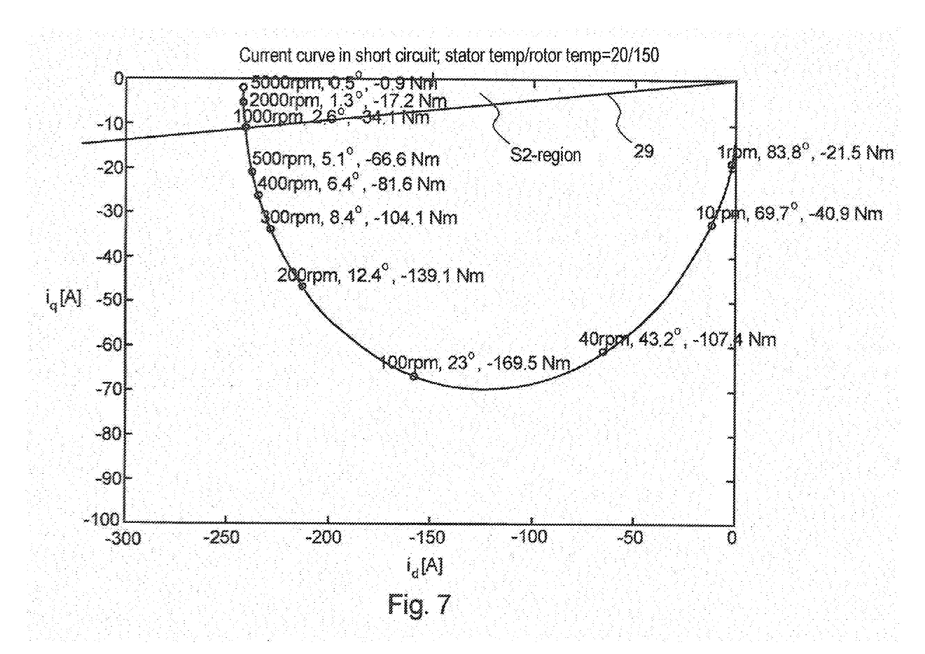

FIG. 7 shows a shape of a curve of a synchronous machine in the short-circuit mode at a stator temperature of 20° Celsius and a rotor temperature of 150° Celsius.

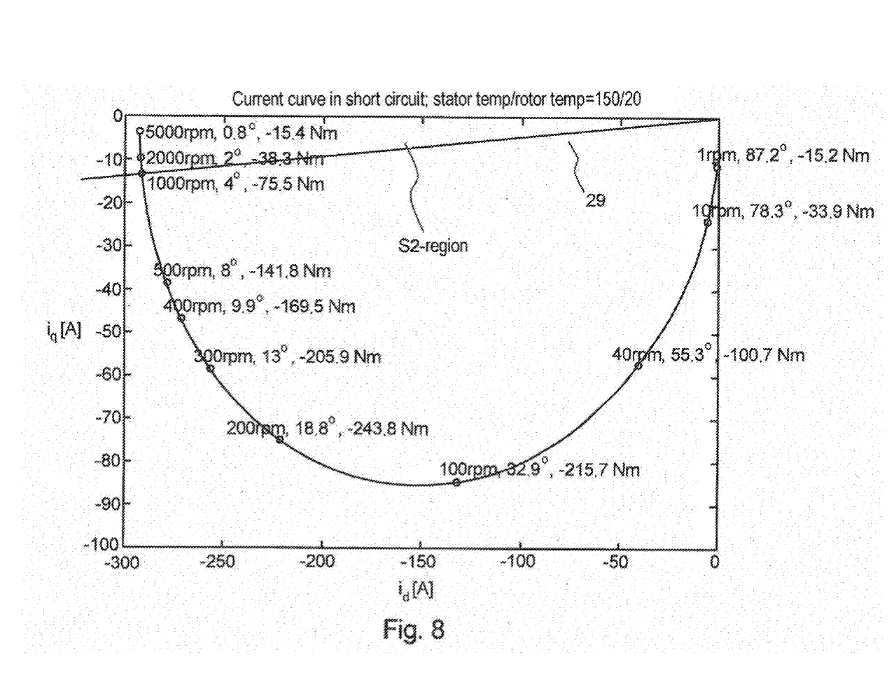

FIG. 8 shows a shape of a curve of a synchronous machine in the short-circuit mode at a stator temperature of 150° Celsius and a rotor temperature of 20° Celsius.

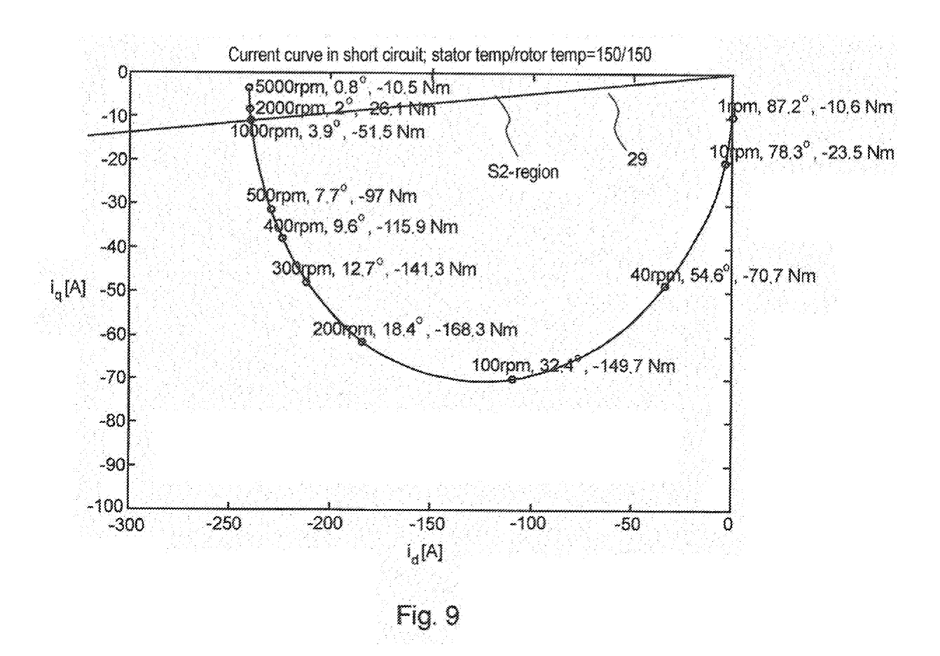

FIG. 9 shows a shape of a curve of a synchronous machine in the short-circuit mode at a stator temperature of 150° Celsius and a rotor temperature of 150° Celsius.

A range S2 in which only a small amount of torque is generated can be identified in all the FIGS. 6, 7, 8, 9. The occurrence of this operating state having a small amount of braking torque is independent of a variation of the stator and/or rotor temperature. The S2 threshold 29 must be defined such that the maximum permissible braking torque is not exceeded.

It is noted that the term “comprise” does not rule out further elements or method steps, and the term “one” does not rule out multiple elements and steps.

The reference numbers used are intended solely to increase the comprehensibility and should in no way be considered limiting, wherein the scope of protection of the invention is reflected by the claims.

### LIST OF REFERENCE NUMBERS

1 voltage source
2 voltage intermediate circuit
3 intermediate circuit capacitor
4 high-side power switch
5 high-side freewheeling diode
6 low-side freewheeling diode
7 low-side power switch
8 permanent magnet-excited synchronous machine
9 means for measuring the position of the rotor
10 transition region
11 maximum amount of speed
12 current measurement
13 control unit for controlling the frequency converter
14 monitoring unit
15 fault and error detection
16 external fault/error signal
17 fault detected
18 Current flow outside the tolerance range T1?
19 Control signals active?
20 Is the current angle/current ratio within the S1 range?
21 switching on of the disconnect mode by the monitoring unit
22 Current flow outside the tolerance range T1?
23 switching on of the short-circuit mode by the monitoring unit
24 Is the current angle/current ratio outside the S2 range?
25 characteristic curve K_mot (operation as a motor)
26 characteristic curve K_gen (operation as a generator)
27 linearized characteristic curve, S1_mot
28 linearized characteristic curve, S1_gen
29 curve
30 curve
i_{d} d-current in the rotor-oriented coordinate system
i_{q} q-current in the rotor-oriented coordinate system
i_{U} current in the phase conductor U
i_{V} current in the phase conductor V
i_{W} current in the phase conductor W
S1 region in the transformation plane, within which a field weakening is present
S2 region in the transformation plane, in which only a small amount of braking torque is generated in the short-circuit case
T1 region in the transformation plane, within which only low currents occur
U phase conductor voltage
V phase conductor voltage
W phase conductor voltage
GND ground of the DC voltage
PSM permanent magnet-excited synchronous machine
U_{BAT} DC voltage

1-13. (canceled)

14. A method of controlling a multiphase frequency converter for controlling an electric machine, the frequency converter including power circuit pairs, each of which has a first power switch and a second power switch connected in series with the first power switch, wherein the first power switch is connected to a DC voltage and the second power switch is connected to a ground of the DC voltage, and wherein each node between the first power switch and the second power switch is connected to a respective phase conductor of the electric machine, the method comprising:
ascertaining whether a fault is present;
if a fault is present and a control signal at one or both of the first and second power switches is not active: assessing whether the frequency converter should be switched into a short-circuit mode or into a freewheeling mode on a basis of phase conductor currents and/or on a basis of a position of a rotor of the electric machine.

15. The method according to claim 14, further comprising:
mathematically transforming the phase conductor currents into a two-dimensional coordinate system having current components oriented orthogonal to one another and/or a coordinate system which is a rotor-oriented coordinate system.

16. The method according to claim 15, further comprising:
if the current components are within a tolerance range: transferring the output stage into a freewheeling mode;
if the current components are outside the tolerance range, if the control signal is active, or if the current components are outside a first range: transferring the frequency converter into the freewheeling mode.

17. The method according to claim 16, wherein the tolerance range is a range in which the following applies for the current components: iq2+id2=first value, and/or wherein the first range is the range in which the following applies for the current components: id<0 and (iq<=|second value·id| and iq>=third value·id) and/or wherein the first value, the second value, and the third value are identical or different numerical values and/or wherein the determination as to whether the current components are within the first range comprises calculating a current angle of the current components and/or calculating a current ratio of the current components.

18. The method according to claim 16, further comprising:
if the current components are outside the tolerance range: transferring the frequency converter into the short-circuit mode; and
if the current components are within the tolerance range: leaving the frequency converter in the freewheeling mode.

19. The method according to claim 15, further comprising:
if the current components are outside a tolerance range and if the control signal is not active: transferring the frequency converter into the short-circuit mode;
if the current components are outside the tolerance range, if the control signal is active, and if the current components are within a first range: transferring the frequency converter into the short-circuit mode.

20. The method according to claim 19, wherein the tolerance range is a range in which the following applies for the current components: iq2+id2=first value, and/or wherein the first range is the range in which the following applies for the current components: id<0 and (iq<=|second value·id| and iq>=third value·id) and/or wherein the first value, the second value, and the third value are identical or different numerical values and/or wherein the determination as to whether the current components are within the first range comprises calculating a current angle of the current components and/or calculating a current ratio of the current components.

21. The method according to claim 20, further comprising:
if the current components are outside the tolerance range: transferring the frequency converter into the short-circuit mode; and
if the current components are within the tolerance range: leaving the frequency converter in the freewheeling mode.

22. The method according to claim 20, further comprising:
if the current components are within a second range: leaving the frequency converter in the short-circuit mode;
if the current components are outside the second range: transferring the frequency converter into the disconnect mode.

23. The method according to claim 19, further comprising:
if the current components are within a second range: leaving the frequency converter in the short-circuit mode;
if the current components are outside the second range: transferring the frequency converter into the disconnect mode.

24. The method according to claim 23, wherein the second range is a range in which the following applies for the current components: id<0 and (iq<=0 and iq>=fourth value·id), wherein the fourth value is any numerical value and/or wherein the second range is determined by calculating a current angle of the current components and/or by calculating a current ratio of the current components.

25. The method according to claim 14, which comprises, in the freewheeling mode, keeping all the first and all the second power switches open.

26. The method according to claim 14, wherein, in the short-circuit mode, all the first power switches are open and all the second power switches are closed or wherein all the first power switches are closed and all the second power switches are open or wherein one power switch is short-circuited in each phase.

27. The method according to claim 14, which comprises transferring the frequency converter into the freewheeling mode and/or into the short-circuit mode with a monitoring unit.

28. A control unit configured to carry out the method according to claim 14.

29. A vehicle, comprising a control unit according to claim 28.
